(19) United States
(12) Patent Application Publication
(10) Pub. No.: US 2007/0249795 A1
(43) Pub. Date: Oct. 25, 2007

(54) Photopolymerisable materials for use in wound dressing

(76) Inventor: Yousef Samih Taktak, Derbyshire (GB)

Correspondence Address: MCHALE & SLAVIN, P.A., 2855 PGA BLVD, PALM BEACH GARDENS, FL, 33410, US

(21) Appl. No.: 11/573,833

(22) PCT Filed: Jun. 3, 2005
(86) PCT No.: PCT/GB05/02196

§ 371 Date: Feb. 16, 2007

(30) Foreign Application Priority Data
Aug. 19, 2004 (GB) 0418522.9

(51) Int. Cl. C08F 26/10

(52) U.S. Cl. 526/264; 526/303.1; 526/319; 526/318.43; 525/326.9; 525/330.3

(57) ABSTRACT

A composition that is photopolymerisable in the presence of water comprising: (a) a first water-soluble monomer having olefinic unsaturation and a flexible hydrophilic chain; (b) from 0.2 to 20 parts by weight, based on the weight of the first monomer, of a second water soluble monomer having olefinic unsaturation and a group that imparts tackiness on curing, and which is of high free radical polymerization efficiency; (c) from 0.001 to 0.5 parts by weight, based on the weight of the first monomer, of a cross-linking agent; (d) from 0.001 to 0.5 parts by weight, based on the weight of the first monomer, of a photoinitiator; and (e) from greater than 20% up to 50% by weight, based on the total weight of the composition, of a low molecular weight polyol.

### FIELD OF THE INVENTION

The present invention relates to polymerisable materials, and more particularly to a photopolymerisable composition, to an adhesive composition obtainable by polymerising said composition, and to the use of the adhesive composition, for example, in the production of wound dressings. The invention is especially, but not exclusively, applicable to the production of sheet material for use as hydrogel wound dressings for the treatment of open wounds, surgical openings and incisions.

### BACKGROUND OF THE INVENTION

Hydrogels based on carbohydrate-derived materials and their applications to wound dressings are well-known. Such materials are described, for example, in WO95/17166, EP-A-0455324, WO88/08310, WO98/19311 and elsewhere.

In particular, in WO 00/14131 there is described a composition that is photopolymerisable in the presence of water and comprises:

(a) a first monomer having olefinic unsaturation and a flexible hydrophilic chain;

(b) a second monomer having olefinic unsaturation and high polymerisation efficiency and which can contribute to tackiness on curing;

(c) a cross-linking agent; and

(d) a photoinitiator.

WO 00/14131 also describes an adhesive gel composition obtained by photopolymerising the above composition.

In the production of a suitable hydrogel for use in a wound dressing many competing requirements need to be met. The hydrogel should preferably adhere to the skin around a wound, but should be removable by peeling, without discomfort to the patient, without tearing and without damage to the area of healing. The hydrogel should preferably be conformable to the wound area and is desirably stretchable and cohesive on hydration. It should not be cytotoxic or give rise to haemolysis. It is preferably clear or transparent, so that the progress of wound healing can be observed. The hydrogel should also be capable of absorbing wound secretions and should be free of components that can leach into a wound and disturb granulating tissue. Finally, the hydrogel should be sterilisable, preferably by irradiation. The composition of WO 00/14131 has many of the above desirable properties but has been found to be seriously deficient in that it cannot be sterilised by irradiation without losing all, or substantially all, of its ability to adhere to skin. Since irradiation is the sterilisation method of choice, this renders the composition substantially less desirable as a wound dressing.

WO 00/14131 proposes the addition of from 2 to 20% by weight of propylene diol (propane-1,2-diol) to the photopolymerisable composition to assist in providing an appropriate level of tackiness, but the compositions of WO 00/14131 containing up to 20% by weight of propylene diol have been found in practice not to provide adequate adhesion to human skin after irradiation. Furthermore, in the examples of WO00/14131, the addition of over 10% by weight of propylene diol is stated to produce undesirably high tackiness (Example II), and over 16% by weight of propylene diol is stated to lead to phase separation (Example 14).

Accordingly there remains a need for a hydrogel that can be sterilised by irradiation for use as an adhesive wound dressing.

### SUMMARY OF INVENTION

Surprisingly it has been found that with the appropriate choice of starting materials, it is possible to produce a photopolymerisable composition that can be formed into an adhesive composition for a wound dressing that can be sterilised by irradiation.

According to a first aspect of the present invention there is provided a composition that is photopolymerisable in the presence of water comprising:

(a) a first monomer having olefinic unsaturation and a flexible hydrophilic chain;

(b) from 0.2 to 20 parts by weight, based on the weight of the first monomer, of a second monomer having olefinic unsaturation and a group that imparts tackiness on curing, and which is of high free radical polymerisation efficiency;

(c) from 0.001 to 0.5 parts by weight, based on the weight of the first monomer, of a cross-linking agent;

(d) from 0.001 to 0.5 parts by weight, based on the weight of the first monomer, of a photoinitiator; and

(e) from greater than 20% up to 50% by weight, based on the total weight of the composition, of a low molecular weight polyol.

In a second aspect the invention provides a method for making an adhesive gel composition which comprises exposing to light an aqueous solution comprising the components (a) to (e) above.

In a third aspect the invention provides a method for making a sterile adhesive wound dressing which comprises subjecting the gel composition in sheet form to irradiation.

### DETAILED DESCRIPTION OF THE INVENTION

First Monomer

In the above composition, the first monomer is a water-soluble compound that has olefinic unsaturation and a flexible hydrophilic chain, preferably an oligomeric polyoxyalkylene chain connected to an ethylene or other alkylene group. A preferred class of compounds is of the formula: 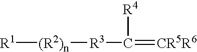
in which:

R¹ represents hydroxyl or C₁-C₄ alkoxy;

R² represents C₂-C₃ alkoxy;

R³ is —O— or —CO—;

R⁴, R⁵ and R⁶ represents hydrogen or C₁-C₄ alkyl; and

n is 1-25, preferably about 5-10.

The polyoxyalkylene chain may be a polyethylene glycol chain that may contain minor amounts of polypropylene glycol or other units that do not interfere with its hydrophilic character or impart toxicity. In a particularly preferred class of compounds of the above formula, R¹ represents hydroxyl-, methoxy-, or ethoxy-, R² represents ethoxy-(optionally with a minor amount of propoxy- or other alkoxy- units), R³ represents —CO—, R⁴ represents methyl and R⁵ and R⁶ represent hydrogen.

Preferred compounds are of the formulae:

CH₃,CH₂,O(CH₂CH₂O)ₙCOC(CH₃)═CH₂

H₃CO(CH₂CH₂O)ₙCOC(CH₃)—CH₂ or

HO(CH₂CH₂O)ₙCOC(CH₃)—CH₂

in which n is as defined above. Also preferred for some applications are compounds of the formula:

CH₂═CHCH₃)—CO[OCH₂CH₂(CH₃)]ₚ[OCH₂CH₂]_{q}OH

Where p and q are positive integers, subject to the proviso that the sum of p and q is in the range 2-25, preferably about 5-10.

All the above compounds are preferably in the form of water-soluble liquids. Their molecular weights are preferably in the range 200-700, more preferably 300-600 and most preferably about 350-400.

Second Monomer

The second monomer is a water soluble compound that may be of the formula:

CH₂═CR⁷R⁸

Wherein R⁷ represents hydrogen or methyl and R⁸ represents a non-oligomeric polar non-ionic group that imparts skin-adhesion but does not impart toxicity to the resulting polymer gel. Examples of R⁸ may include

—CONR⁹R¹⁰

wherein R⁹R¹⁰ represents hydrogen, lower (C₁-C₄) alkyl or lower hydroxyalkyl. Compounds of this class include acrylamide, methacrylamide, N,N-dimethylacrylamide and N-(2-hydroxypropyl)-methacrylamide. R⁸ may also include

—COOR¹¹

wherein R¹¹ represents a C₁-C₄ mono, di or poly-hydroxyalkyl group. Compounds of this class include 2-hydroxyethyl acrylate, 2-hydroxyethyl methacrylate, glyceryl monoacrylate or glyceryl monomethacrylate. R⁸ may also include substituted amino groups including cyclic groups to which the nitrogen atom is bonded, the cyclic group optionally being substituted with >C═O or an —OH group. A suitable compound is N-vinyl pyrrolidone. R⁸ may also include alkylsulfone groups, a suitable compound being vinyl methyl sulfone.

Cross-Linking Agents

The cross-linking agent is preferably of formula:

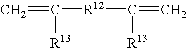

wherein R¹³ represents H or CH₃ and R¹² represents a polar linking group and is preferably water soluble. R¹² can be selected to provide the desired combination of properties and in general the greater the length between the olefinic groups, the more macroporous the gel. Suitable cross-linking agents are water-soluble or water miscible diolefinic acrylates or methacrylates, e.g:

CH₂═CH(CH₃)—CO—O—CH₂—CH₂—O—COCH(CH₃)═CH₂

CH₂═CH—CO—NH—CH₂—NH—CO—CH═CH₂ and

CH₂═C(CH₃)—CO—O—(CH₂CH₂O)ₙ—O—CO—C(CH₃)═CH₂

wherein n is an integer.

When the polymerisation is carried out in an aqueous system, the cross linking agent is preferably water soluble.

Photoinitiator

Any suitable photoinitiator may be used, provided that it does not leave cytotoxic residues in the hydrogel after polymerisation. Examples of preferred photoinitiators include

2-hydroxy-2-methyl-1-phenyl-propan-1-one

Low Molecular Weight Polyol

The low molecular weight polyol can be, for example, ethylene glycol, propylene glycol, a low molecular weight polyethylene glycol (eg MW less than 1000, preferably less than 500) or glycerol. Without wishing to be bound by any particular theory, it is believed that part of the polyol may become incorporated into the polymer structure through chain transfer and that part of the polyol remains unincorporated.

In particularly preferred compositions according to the invention, the first monomer is polyethylene glycol monomethacrylate, the second monomer is 2-hydroxyethyl acrylate, the cross-linking agent is polyethylene glycol dimethacrylate and the polyol is propylene glycol.

Further Features of the Invention

It has been found that the correct choice of components and relative quantities is important for obtaining a hydrogel with the desired adhesive properties after sterilisation by gamma or beta irradiation. Preferably the first monomer is a hydroxyl-terminated material.

Preferably the second monomer is a hydroxyl-substituted acrylate or methacrylate, and is present is an amount of from 0.2 to 20 parts by weight, most preferably from 1 to 10 parts by weight, based on the weight of the first monomer.

Preferably the cross-linking agent is a water soluble diolefinic acrylate or methacrylate, and is present in an amount of from 0.001 to 0.5 parts by weight, most preferably from 0.03 to 0.3 parts by weight, based on the weight of the first monomer.

Preferably the low molecular weight polyol is propylene glycol. The amount of polyol added will depend upon the desired tackiness of the composition after irradiation. Preferably the polyol is present in an amount of from 25 to 45% by weight, more preferably from 30 to 45% by weight, most preferably from 35 to 45% by weight.

The uncured compositions of the invention may further comprise a thickener, especially in those instances where the weight of the first monomer is relatively low compared to that of the second monomer e.g. they are in a weight ratio of about 1:10. For example, polyvinyl alcohol imparts viscosity to the uncured composition and permits the composition to be cast onto release paper. If it is not presents it may become difficult to obtain a uniform layer. The amount incorporated is also selected having regard to the desired tackiness of the cured composition—an increase in the amount of polyvinyl alcohol incorporated generally brings about a reduction in the tackiness of the cured composition. Carbohydrate-based thickeners may also be incorporated, for example, chitosan (which is preferred because it is believed to have healing properties), carrageenan, or guar gum.

If the gel composition is not to be used extemporaneously, but has to be stored and/or transported before it is cured, addition of a free-radical polymerisation inhibitor, e.g. 4-methoxyphenol or hydroquinone, may be desirable to prevent premature polymerisation.

The composition may further comprise a biologically active material that is retained on polymerisation and becomes gradually released from the polymerised composition when in position on the human or animal body. In the case of a flat sheet hydrogel for use as a wound dressing, the biologically active material can be, for example, a growth factor, an antibacterial agent, an anti-fungal agent, an antiseptic agent, an anaesthetic agent, a debriding agent, an anti-inflammatory agent, an enzyme, or a cell nutrient. In the case of transdermal patches, the composition can further comprise a transdermally administrable drug.

Polymerising the Composition

The composition may be polymerised by UV light and may be pre-formed into a layer of thickness 0.1-3 mm, typically about 1.5 mm by pouring the mixture onto a substrate, and polymerising the mixture by light to form a water-insoluble sheet gel which is transparent, coherent, adhesion and water absorbent. The polymerised sheet is self-supporting and does not require internal reinforcement, which is an advantage where stretchability is a desideratum. However, if desired, a reinforcing agent, for example, a mesh of textile material, may be incorporated into the composition before it is polymerised. In the case of a sheet composition there may be also provided a backing sheet and a sheet of release paper to permit application to the skin.

Small quantities of the hydrogel can be made in batches by passing polymerisation mixtures into a tray past a UV light source and removing the resulting polymerised sheet from the tray. Larger quantities may be produced using an endless belt e.g. of release coated plastics material which passes successively through a casting station where polymerisation mixture is poured onto the belt to a desired depth, a polymerisation station where UV light is applied to the mixture, a stripping station where the sheet of hydrogel is removed from the belt, and a cutting station where the stripped sheet is cut to convenient size pieces.

The cut sheet may be sterilised, preferably by irradiation, and packed into a blister pack or in a sealed pouch.

Use of the Composition

Particular applications of flat sheet gel are wound dressings e.g. for burns as explained above, for surgical openings and incisions, for example, in colostomy, for drug delivery patches and for microbiological swabs.

Irradiation

The cured hydrogel can be sterilised by particle irradiation, for example, by beta-irradiation (electron beam), but preferably the hydrogel is sterilised by gamma-irradiation to form a sterilised wound dressing. Typically radiation doses are in the range of from 15 to 55 Kilo Gray. The effect of irradiation is substantially to reduce the tackiness and adhesion of the hydrogel, but it has been found in accordance with preferred embodiments of the invention that by appropriate selection of the components of the curable composition an excellent sterilised adhesive hydrogel wound dressing can be obtained.

Tackiness

The right degree of tackiness of the polymerised, irradiated composition is very significant in its success as a wound dressing. Ideally the hydrogel should adhere well to dry skin, but only weakly to moist skin so that it can be removed from a wound site without damage to the area of healing.

However, even where the hydrogel adheres well, it should be capable of easy removal by peeling without discomfort. Preferably the tensile strength of the hydrogel is greater than its adhesive peel strength, so that it can be readily removed without tearing or disintegration. Preferably the adhesive peel strength of the irradiated hydrogel to dry human skin is at least 1.0N, but not greater than 2.5N, in order that it can be peeled without discomfort. Most preferably the adhesive peel strength of the irradiated hydrogel to human skin is from 1.5 to 2.0 N. In this specifications peel strengths are measured by the skin adhesion test hereinafter described.

The invention is illustrated by the following Examples.

### EXAMPLE 1

### Production of a Hydrogel in Accordance with the Invention

A glass beaker was placed on an electronic balance and 5.00 g of deionised water added thereto. There were then introduced into the beaker by means of a pipette the following components:

8.00 g 2-hydroxyethyl Acrylate

1.00 g Poly(ethylene glycol) Methacrylate, 350 (PEG Mono)

0.15 g Poly(ethylene glycol) dimethacrylate (PEG Di)

0.25 g Darocure 1173

5.00 g Glycerol

5.25 g or 7.00 g or 8.75 g or 10.50 g or 14.00 g Propylene Glycol (1,2-propanediol)

The percentages of propylene glycol by weight, based on the total weight of the composition, in these formulations were:

21.3%, 26.5%, 31.1%, 35.1%, 41.9% respectively.

The components were mixed thoroughly and then formed into a thin layer on a piece of siliconised release paper. This was passed beneath a UV curing apparatus comprising a Fusion LC6E conveyor running at a speed of 5 revolutions per minute. The bulb used was 15 cm long and had a wavelength of 200-400 nm. A self-supporting sheet of tacky gel was formed on the release paper. The gel was flexible and easy to remove from the release paper. The gel was sterilised with a dose of 25 Kilo Gray of gamma irradiation. After irradiation it adhered well to dry skin but exhibited little or no adhesion to moist skin.

The gel maintained its transparency, stretchability and coherence on absorption of water. Its weight, area and thickness increased, but it remained clear and handleable. It could be replaced on dry skin to which it remained adherent. Bio-testing by extraction with saline and contact of the saline extract with red blood cells showed no evidence of haemolysis and cytotoxicity. It was concluded that the cured gel was free of toxic quantities of untreated monomer.

Further evaluation of the gel was carried out, and in particular it passed tests for cytotoxicity, skin irritation and haemolysis.

The gel was also tested for water uptake. A weighed sample of the gel was placed in a solution of sodium chloride (5.6 g) in water (600 ml), and was removed and reweighed at timed intervals. After 24 hours it was found to have taken up about 100% of its own weight of water.

Skin Adhesion Test

The gel was tested for skin adhesion using the following procedure. A layer of the gel covered on both faces with siliconised release paper was cut to form a sample 2.5 cm wide and 10 cm long. At one end of the sample, a small area of the gel layer was separated from the release paper and a bulldog clip was attached to the gel layer. Release paper was removed from one face, which was applied to shaven human skin, the release paper on the other face being left in place to avoid the gel drying out. Care was taken to eliminate air bubbles, and a 500 g weight was passed 5-6 times over the release paper to press the underlying gel layer firmly against the skin. The bulldog clip was connected to one end of a force measuring device whose other end was connected to an electric motor via a thread. Energising the motor caused it to tension the thread and pull the gel layer from the skin. The force to pull the gel layer off the skin was recorded.

The results of the skin adhesion test are given in Table 1:

TABLE 1

| Wgt % of Propylene Glycol | Skin Adhesion (N) |
|---|---|
| 21.3 | 1.0 |
| 26.5 | 1.2 |
| 31.1 | 1.5 |
| 35.1 | 2.0 |
| 41.9 | 2.2 |

In a further comparative example, the procedure outlined above was repeated but using 20% by weight of propylene glycol in the composition. The skin adhesion of this composition was less than 1N.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A composition that is photopolymerisable in the presence of water comprising:
(a) a first water-soluble monomer having olefinic unsaturation and a flexible hydrophilic chain;
(b) from 0.2 to 20 parts by weight, based on the weight of the first monomer, of a second water soluble monomer having olefinic unsaturation and a group that imparts tackiness on curing, and which is of high free radical polymerisation efficiency;
(c) from 0.001 to 0.5 parts by weight, based on the weight of the first monomer, of a cross-linking agent;
(d) from 0.001 to 0.5 parts by weight, based on the weight of the first monomer, of a photoinitiator; and
(e) from greater than 20% up to 50% by weight, based on the total weight of the composition, of a low molecular weight polyol.

2. A composition according to claim 1, wherein the first monomer comprises an oligomeric polyoxyalkylene chain connected to an ethylene or other alkylene group.

3. A composition according to claim 1 or 2, wherein the first monomer is a compound of the formula: 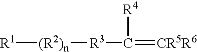
in which:
R¹ represents hydroxyl or C₁-C₄ alkoxy;
R² represents C₂-C₃ alkoxy;
R³ is —O— or —CO—;
R⁴, R⁵ and R⁶ represents hydrogen or C₁-C₄ alkyl; and
n is 1-25.

4. A composition according to claim 2 wherein the polyoxyalkylene chain is a polyethylene glycol chain that optionally contains minor amounts of polypropylene glycol or other units that do not interfere with its hydrophilic character or impart toxicity.

5. A composition according to claim 3, wherein R¹ represents hydroxyl-, methoxy-, or ethoxy-, R² represents ethoxy-(optionally with a minor amount of propoxy- or other alkoxy- units), R³ represents —CO—, R⁴ represents methyl and R⁵ and R⁶ represent hydrogen.

6. A composition according to claim 1, wherein the first monomer is:
CH₃, CH₂,O(CH₂CH₂O)ₙCOC(CH₃)═CH₂
H₃CO(CH₂CH₂O)ₙCOC(CH₃)—CH₂ or
HO(CH₂CH₂O)ₙCOC(CH₃)—CH₂
in which n is an integer of from 1 to 25, or wherein the first monomer is:
CH₂═CHCH₃)—CO[OCH₂CH₂(CH₃)]ₚ[OCH₂CH₂]_{q}OH
Where p and q are positive integers, subject to the proviso that the sum of p and q is in the range 2-25.

7. A composition according to claim 1, wherein the first monomer is a water-soluble liquid having a molecular weight in the range 200-700.

8. A composition according to any one of claim 1, wherein the second monomer is a compound of the formula:
CH₂═CR⁷R⁸
Wherein R⁷ represents hydrogen or methyl and R⁸ represents a non-oligomeric polar non-ionic group that imparts skin-adhesion but does not impart toxicity to the resulting polymer gel.

9. A composition according to claim 8, wherein R⁸ is :
—CONR⁹R¹⁰
wherein R⁹R¹⁰ represents hydrogen, lower (C₁-C₄) alkyl or lower hydroxyalkyl, or wherein R⁸ is
—COOR¹¹
wherein R¹¹ represents a C₁-C₄ mono, di or poly-hydroxyalkyl group, or wherein R⁸ is a substituted amino group, including cyclic groups to which the nitrogen atom is bonded, the cyclic group optionally being substituted with >C═O or an —OH group, or wherein R⁸ is an alkylsulfone group.

10. A composition according to claim 9, wherein the second monomer is acrylamide, methacrylamide, N,N-dimethylacrylamide or N-(2-hydroxypropyl)-methacrylamide; 2-hydroxyethyl acrylate, 2-hydroxyethyl methacrylate, glyceryl monoacrylate or glyceryl monomethacrylate; N-vinyl pyrrolidone; or vinyl methyl sulfone.

11. A composition according to claim 1 wherein the cross-linking agent is of the formula: 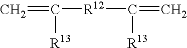
wherein R¹³ represents H or CH₃ and R¹² represents a polar linking group.

12. A composition according to claim 11, wherein the cross-linking agent is a water-soluble or water miscible diolefinic acrylate or methacrylate.

13. A composition according to claim 12, wherein the cross-linking agent is
CH₂═CH (CH₃)—CO—O—CH₂—CH₂—O—COCH(CH₃)═CH₂
CH₂═CH—CO—NH—CH₂—NH—CO—CH═CH₂ or
CH₂═C(CH₃)—CO—O—(CH₂CH₂O)ₙ—O—CO—C(CH₃)═CH₂
wherein n is an integer.

14. A composition according to claim 1, wherein the photoinitiator is 2-hydroxy-2-methyl-1-phenyl-propan-1-one

15. A composition according to claim 1 wherein the low molecular weight polyol is ethylene glycol, propylene glycol, a low molecular weight polyethylene glycol, or glycerol.

16. A composition according to claim 1, wherein the first monomer is polyethylene glycol monomethacrylate, the second monomer is 2-hydroxyethyl acrylate, the cross-linking agent is polyethylene glycol dimethacrylate and the polyol is propylene glycol.

17. A composition according to claim 1, wherein the second monomer is present in an amount of from 1 to 10 parts by weight, based on the weight of the first monomer.

18. A composition according to claim 1, wherein the cross-linking agent is present in an amount of from 0.03 to 0.3 parts by weight, based on the weight of the first monomer.

19. A composition according to claim 1, wherein the low molecular weight polyol is present in an amount of from 25 to 45% by weight, based on the total weight of the composition.

20. A composition according to claim 1, wherein the low molecular weight polyol is present in an amount of from 35 to 45% by weight, based on the total weight of the composition.

21. A composition according to claim 1, further comprising a thickener.

22. A composition according to claim 1, further comprising a biologically active material that is retained on polymerisation and becomes gradually released from the polymerised composition when in position on the human or animal body.

23. A composition according to claim 22, wherein the biologically active material is a growth factor, an antibacterial agent, an anti-fungal agent, an antiseptic agent, an anaesthetic agent, a debriding agent, an anti-inflammatory agent, an enzyme, or a cell nutrient.

24. (canceled)

25. A method of manufacturing an adhesive composition comprising:
providing a photopolymerisable composition formed from (a) a first water-soluble monomer having olefinic unsaturation and a flexible hydrophilic chain; (b) from 0.2 to 20 parts by weight, based on the weight of the first monomer, of a second water soluble monomer having olefinic unsaturation and a group that imparts tackiness on curing, and which is of high free radical polymerisation efficiency; (c) from 0.001 to 0.5 parts by weight, based on the weight of the first monomer, of a cross-linking agent; (d) from 0.001 to 0.5 parts by weight, based on the weight of the first monomer, of a photoinitiator; and (e) from greater than 20% up to 50% by weight, based on the total weight of the composition, of a low molecular weight polyol; and
photopolymerising said composition in the presence of UV light;
whereby an adhesive composition is formed.

26. An adhesive composition produced by the method of claim 25.

27. A sterilised adhesive composition produced by irradiating the adhesive composition of claim 26.

28. A composition according to claim 26 or 27, having an adhesive peel strength of from 1.0N to 2.5N.

29. A composition according to claim 28, having an adhesive peel strength of from 1.5N to 2.0N.

30. An adhesive composition according to claim 26 or 27, in the form of a flat sheet.

31. A wound dressing comprising an adhesive composition according to claim 26 or 27.

32. A cross-linked polymer composition comprising polymerised residues of polyethylene glycol monomethacrylate, 2-hydroxyethyl acrylate and polyethylene glycol dimethacrylate, and further comprising propylene glycol.
